(19) United States
(12) Patent Application Publication
(10) Pub. No.: US 2017/0364897 A1
(43) Pub. Date: Dec. 21, 2017

(54) METHOD AND SYSTEM FOR A SEAMLESS TRANSITION BETWEEN A SMALLER SIZED DISPLAY AND A LARGER SIZED DISPLAY DURING PURCHASING INTERACTIONS

(71) Applicants: Anjana Sarkar, San Francisco, CA (US); Vijay Jain, San Francisco, CA (US)

(72) Inventors: Anjana Sarkar, San Francisco, CA (US); Vijay Jain, San Francisco, CA (US)

(21) Appl. No.: 15/183,344

(22) Filed: Jun. 15, 2016

(51) Int. Cl. G06Q 20/32; G06Q 20/40; G06Q 30/06; H04L 29/06

(52) U.S. Cl. CPC G06Q 20/322; H04L 63/0876; G06Q 20/40; G06Q 30/0631; G06Q 30/0643

(57) ABSTRACT

A computerized method for providing a seamless transition between a first device with a first display size and a second device with a second display size during a purchasing transaction. A transaction server receives authentication information of a user from a first device. The transaction server stores the authentication information and further receives a potential authentication information from the user captured by a second device. The transaction server compares the potential authentication information to the authentication information. The transaction server determines whether the potential authentication information matches the authentication information. The server transmits a response to the second device in response to the determining. In response to the transmitted response being a successful verification of the potential authentication information, the transaction server receives a transaction request from the first device to complete the purchasing transaction at the transaction server.

### FIELD OF INVENTION

This invention generally relates to at least a system of devices, including point-of-sale devices, a transaction server, and mobile devices of users that provide intelligence to purchasing recommendations.

### BACKGROUND

The convenience of mobile devices, such as smartphones and smart watches, has increased users' ability to access information more frequently and easily. The scope of this access has also expanded from simple information retrieval to more interactive accesses, thanks to the higher connectivity capacity of wireless networks through cellular protocols. One of these accesses is shopping or purchasing activities by the users on their mobile devices.

Also, one would appreciate that, in most of the shopping experience, visual representations of items for purchase are an important piece of the experience—users want to have a closer look at the item. This desire could be challenging when the screen of the mobile device of a user is too small or not having a crisp resolution. It is true that smartphone manufacturers have been expanding the size of the smartphone screens to accommodate such desire, but a user could only tolerate the size to a certain point, e.g., a screen size with no more than perhaps 6 inches in length diagonally. It is also impractical to require a user to carry a larger display device, such as a laptop, just to enjoy a better shopping experience—the ability to zoom-in closely to the items for purchase while enjoying a crisp resolution. Moreover, shopping or purchasing experience needs to be secured. Therefore, a better purchasing experience for the user should be available.

### SUMMARY

Embodiments of the invention provide a seamless transition between a device with a smaller display and a device with a larger display during purchasing interactions while still maintaining security and privacy. In one embodiment, as an initial step, authentication information about the user may be transmitted to a transaction server for storage a data store. The user may interact with a device with a larger display, such as a touch-sensitive display monitor with at least 36 inches measured diagonally. The user may browse through one or more merchandize offerings from a seller or a store. Through the display, the user may select one or more items to use or purchase. The user may then be prompted to be authenticated. Once authenticated, the selected item(s) is/are transmitted to the user's mobile device such that he or she may finalize the transaction on the mobile device.

### BRIEF DESCRIPTION OF THE DRAWINGS

The invention may be better understood by references to the detailed description when considered in connection with the accompanying drawings. The components in the figures may not necessarily be to scale, emphasis instead being placed upon illustrating the principles of the invention. In the figures, like reference numerals designate corresponding parts throughout the different views.

FIG. 1 illustrates an overview of a system of a seamless transition between a smaller display device and a larger display device during purchase interactions according to one embodiment of the invention;

FIG. 2 illustrates a diagram of transmissions of information between a mobile device, a cloud server, and a larger display device according to one embodiment of the invention;

FIG. 3 illustrates a diagram of exemplary data structure of a data packet transmitted to a mobile device according to one embodiment of the invention;

FIG. 4A and FIG. 4B illustrate flow charts of two methods of seamless purchase interactions between a smaller display device and a larger display device according to embodiments of the invention;

FIG. 5 is an illustration of a portable computing device suitable for aspects of the invention; and

FIG. 6 is an illustration of a server computing device suitable for aspects of the invention.

Persons of ordinary skill in the art may appreciate that elements in the figures are illustrated for simplicity and clarity so not all connections and options have been shown to avoid obscuring the inventive aspects. For example, common but well-understood elements that are useful or necessary in a commercially feasible embodiment may often not be depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein may be defined with respect to their corresponding respective areas of inquiry and study except where specific meanings have otherwise been set forth herein.

### DETAILED DESCRIPTION

The present invention may now be described more fully with reference to the accompanying drawings, which form a part hereof, and which show, by way of illustration, specific exemplary embodiments by which the invention may be practiced. These illustrations and exemplary embodiments may be presented with the understanding that the present disclosure is an exemplification of the principles of one or more inventions and may not be intended to limit any one of the inventions to the embodiments illustrated. The invention may be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods, systems, computer readable media, apparatuses, or devices. Accordingly, the present invention may take the form of an entirely hardware embodiment, an entirely software embodiment, or an embodiment combining software and hardware aspects. The following detailed description may, therefore, not to be taken in a limiting sense.

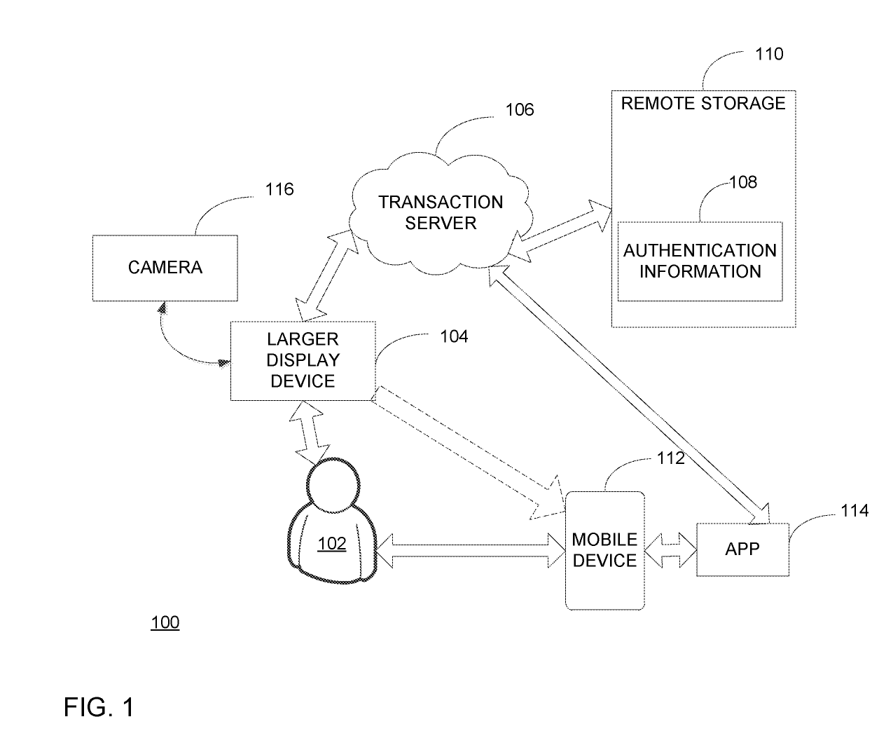

Referring now to FIG. 1, an overview of a system 100 of a seamless transition between a device with a smaller display, such as a mobile device 112, and a larger display device 104 during purchasing interactions according to one embodiment of the invention. In one embodiment, the mobile device 112 is a first device with a first display size and the larger display device 104 is a second device with a second display size. Aspects of the invention further include methods and systems for a seamless, as well as secured, transition of the purchasing experience. the system 100 may include a transaction server 106 that may not be limited to one physical location but are connected in distributed network sense. In another embodiment, the transaction 106 is connected via the Internet or other kinds of computer networks.

The transaction server 106 may be in constant network communications and connections with a remote storage unit 110. According to aspects of the invention, a user 102 may wish to enjoy a seamless transition between the mobile device 112 and the larger display device 104. Embodiments of the invention do not force the user 102 to try to purchase a device with a larger screen display to enjoy the experience of being to perform interactions with a relative large display (e.g., 36 inches display monitor).

In one embodiment, a user 102 may begin with accessing a mobile device 112. In one example, the mobile device 112 may include a cellular phone, a smartphone, a smart watch, a smart wristband, a pair of “smart” glasses, a tablet, etc. In another example, the mobile device 112 may not need to be mobile as the device could also be one's computer that does not typically move, relative to a mobile phone or a smartphone.

In one embodiment, in order to obtain the best experience and benefit of aspects of the invention, the user 102 may install an app or a software product 114 on the mobile device 112. For example, the user 102 may install an app from an app store, and the app 114 may be capable of allowing the user 102 to browse merchandize for purchase. The app 114 is capable of completing the purchase transaction as well. For example, the app 114 may be an app for an online merchant or a brick-and-mortar store with an online portal/interface for placing orders via the Internet. In another embodiment, the app 114 may be an electronic wallet system which connects with other affiliated merchants to making merchandizes available for purchase. In a further embodiment, the app 114 may be in the form of a profile, a certificate, or the like that provides specific configurations or settings in the background while allowing the user 102 to use other “apps” to have the purchasing interactions.

Once the user 102 installs the app 114 on the mobile device 112, the user 102 may be asked to configure the app 114 for the user 102. For example, the app 114 may request a series of authentication information 108, which may include personal information. For example, the series of authentication information 108 may include biometric information, such as fingerprint, a front-facial instant photograph of the user—also known as a selfie—may be used, iris, ear lobe, etc., may be included as part of the authentication information. In another embodiment, additional personal information, such as phone number, work/home address, email address, date of birth, etc., may be needed as part of the authentication information 108. This authentication information 108 may be configured and set as an initial, one-time step such that the app 114 includes the necessary information to identify the user 112.

The app 114 further may include computer executable instructions to collect or generate session information of purchasing interactions of the user 102 on the app 114 on the mobile device 112. For example, the session information may include the time (e.g., duration of the browsing, starting time and approximate end time), items reviewed by the user 102, etc. In another example, the time of the session may be triggered or generated by the interactions from the user 102, such as a search query or a review of a shopping cart of the user 102 via the app 114.

In another embodiment, once the authentication information 108 has been collected by the app 114 from the user 102, the authentication information 108 may be transmitted to the transaction server 106 for storage in the remote storage until 110. In one embodiment, the transaction server 106 may receive the authentication information 108 from a plurality of authentication information 108 from a plurality of sources. As such, the remote storage unit 110 may thus store a plurality of authentication information 108. It is to be understood that the authentication information 108 may be appropriately encrypted to ensure security and privacy protections for the information stored in the remote storage unit 110.

In another embodiment, the transaction server 106 may use the authentication information 108 as a “control” picture for verification purposes, to be further described below. In a further embodiment, the user 102 may visit a store where there are number of kiosks with monitor displays, such as the larger display device 104, showing a number of products. The user 102 may select one or more products and may read details about the product from the larger display device 104. In one example, the larger display device 104 may be a touch-sensitive display, of a size that is greater than or equal to 27 inches measured diagonally, to receive input from the user on the display through direct finger touches or gestures. In another embodiment, the larger display device 104 may include microphones, speakers, alert lights, vibrations, etc., to provide feedbacks to the user 104 to confirm selection or other instructions from the user. It is to be understood that the scope or scale of the size of the larger display device 104 is in reference to the mobile device 112, which is typically no more than 7 inches measured diagonally for a smartphone, no more than 12.5 inches for a tablet, and no more than 17 inches for a laptop. It is also to be understood that the larger display device 104 may be connected to or coupled to other devices or hardware, such as a printer (not shown), a computer (not shown), or server, etc. In aspects of the invention, the larger display device 104 is coupled to or connected to the transaction server 106.

The user 102 may spend a considerable amount of time interacting with items shown by the larger display device 104 (e.g., choosing and identifying products to purchase or use) using the larger display device 104. In one example, the user 102 may interact with the larger display device 104 by taking advantages of the larger display. For example, the user 102 may browse news stories or provide customer feedbacks. In another example, the user 102 may be interested in browsing a product catalog or offerings. As such, the user 102 may interact with the larger display device 104 for a variety of reasons. In response to such interactions, the larger display device 104 may actively determine whether the interactions from the user 102 are interactions relating to purchasing, transactions, or other specific scope.

In one embodiment, the user 102 may choose to purchase an item by adding the selected item to a shopping cart or an electronic basket. In one embodiment, this action triggers a recordation or generation of a session for the user 102. In one example, the recordation may be in the form of a cookie or other record saved in a memory device coupled to the larger display device 104. In another embodiment, the recordation of the session may be triggered when the user 102 starts the interaction with the larger display device 104. In another embodiment, the recordation or generation of the session may be triggered by a timer shown or provided to the user 102. For example, the timer may be started by the user 102 when a user interface is provided to the user 102 to activate the timer. In a further embodiment, the recordation or generation of the session may be initiated based on a recordation the authentication information, as described below. In another example, the session may include a session ID to identify the session. In one embodiment, the session ID may be a unique ID identifying the user 102. In another embodiment, the session ID may use additional information from the user 102 to uniquely identify the user 102.

Still referring to FIG. 1, the larger display device 104 may be connected to or coupled to a camera 116. In one example, the camera 116 may capture a headshot of the user 102 when the user 102 is operating the larger display device 104. As such, the camera 116 uses the headshot or the photograph as a potential authentication information that may be verified as one of the authentication information 108 described above. In one example, the camera 116 may be a high resolution camera (e.g., a resolution greater than or equal to 8 mega pixel). The user 102 may be notified when the camera 116 is about to take the photograph. In another embodiment, the user 102 may be notified at the beginning of the product browsing that a headshot may be taken. For example, as a measure to provide proper notice, the store may provide notices to the user 102 via the larger display device 104 at the beginning of the browsing experience that the larger display device 104 is equipped with the camera 116 and a headshot of the user 102 may be taken. The larger display device 104 may further provide explanations, either in text format or in a pictorial format showing features of embodiments of the invention (i.e., why the photograph is needed for the seamless transition). In another example, the store may notify the user 102 again just right before the camera 116 is about to take the photograph of the user 102 to give the user 102 an opportunity to opt out the aspects of the invention.

Once the user 102 accepts a photograph being taken, either via an explicit authorization prompted by the larger display device 104 or an implicit authorization by continuing to browse product offerings displayed on the larger display device 104, the camera 116 captures the photograph of the user 102 and transmits the photograph to the larger display device 104. The larger display device 104 next may transmit the photograph either to the hardware devices coupled thereto for transmission to the transaction server 106 or through a networking connectivity device (not shown) to the transaction server 106. In one example, the networking connectivity device may be a wireless networking device or a wired networking device.

It is to be understood that the camera 116 and the photographic capture is just one example of identifying the physical presence or appearance in front of the larger display device 104. Other devices may be used, such as a combination of scale, iris scan, voice authentication, etc., may be used without limiting the scope of the invention.

The photograph is next transmitted to the transaction server 106 for a match. In one example, the match may be an approximate match and may require additional information from the user 102 to complete the match. For example, the larger display device 104 may request the user 102 to enter personal information such as phone number, address, email address, etc. If there is no match, the larger display device 104 may provide information to the user 102 to download the app 114 and register an account.

On the other hand, if there is a match, the transaction server 106 may request the session information from the larger display device 104. In one example, the transaction server 106 may request the session information from the larger display device 104 as part of confirming that there is a match of the photograph. Upon receiving the session information, the transaction server 106 may send a data packet to the app 114 installed on the mobile device 112. For example, the transaction 106 may transmit a message containing the data packet to the mobile device 112 and the mobile device 112 may provide a notification to the user 102 that the session from the larger display device 104 is now available on the mobile device 112 to continue.

In an alternative embodiment, the larger display device 104 may transmit the data packet directly to the mobile device 112 via the connectivity device coupled thereto. For example, the connectivity device coupled to the larger display device 104 may include a wireless chip that is includes wireless networking protocols, such as Bluetooth, RFID, NFC, etc. Similarly, the mobile device 112 also includes a wireless hardware capability matching that of the larger display device 104. As such, when the larger display device 104 and the mobile device 112 are within ranges of the wireless signals for both devices, the larger display device 104 may initiate a request to connect to the mobile device 112. The user 102 may be again notified on the larger display device 104 that the larger display device 104 is attempting to connect with the mobile device 112 and may request the user 102 to accept the connection on the mobile device 112. Once connected, the larger display device 104 may transmit the data packet with the session information to the mobile device 112.

As such, once the data packet is transmitted to the mobile device 112, the user 102 may continue the session on the mobile device 112 and terminate the session on the larger display device 104. In one embodiment, the mobile device 112 restores the session that was previously on the larger display device 104 on the mobile device 112. This way, the user 102 has a rich experience using the larger display device 104 and can continue to the mobile device 112 without losing any of the session information and the security of the experience on the mobile device 112. The user 102 may further continue the transaction with the transaction server 106 on the mobile device 112.

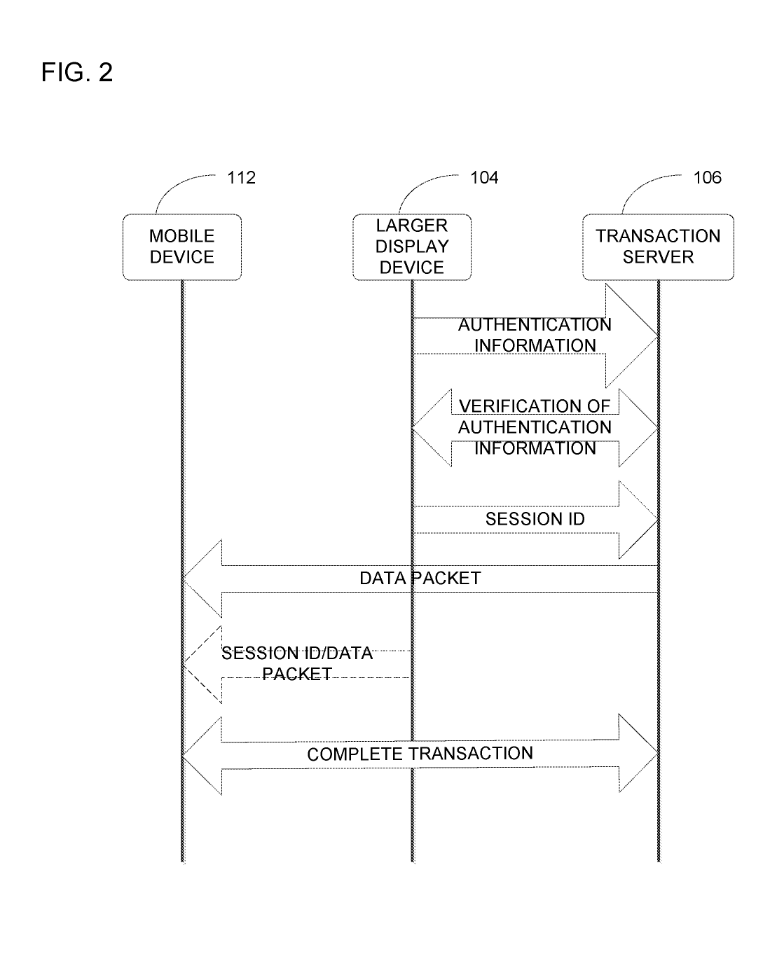

Referring now to FIG. 2, a diagram may illustrate interactions among a transaction server, a mobile device, and a larger display device according to one embodiment of the invention. For example, the transaction server may be the transaction server 106, the mobile device may be the mobile device 112, and the larger display device may be the larger display device 104 described above. In such an example, as illustrated above, the larger display device 104 may transmit the authentication information 108 to the transaction server 106 for storage. The transaction server 106 may transmit, among other data, a verification of the authentication information 108 to the larger display device 104. Also, the larger display device 104 may transmit the session ID to the transaction server 106 once the authentication is verified. The transaction server 106 may transmit the data packet to the mobile device 112 such that the user 102 may continue the session on the mobile device 112. This way, the mobile device 112 may subsequently interchange data with the transaction server 106 to complete the transaction on the mobile device 112.

In another embodiment, the larger display device 104 may transmit the data packet with the session ID to the mobile device 112.

In an alternative embodiment, the user 102 may initiate an interactive session with the app 114 on the mobile device 112 before entering the store where the larger display device 104 is located. The mobile device 112 may also start the recordation of the session information for the user 102 on the app 114. Once the mobile device 112 is within the zone of wireless connectivity with the larger display device 104, the mobile device 112 may transmit the data packet from the mobile device 112 to the larger display device 104. The user 102 may then continue the session on the larger display device 104 without losing any session but also gain a great experience by using the larger display screen. Once on the larger display device 104, the remaining process flow would continue as described above as if the user 102 starts the experience from the larger display device 104.

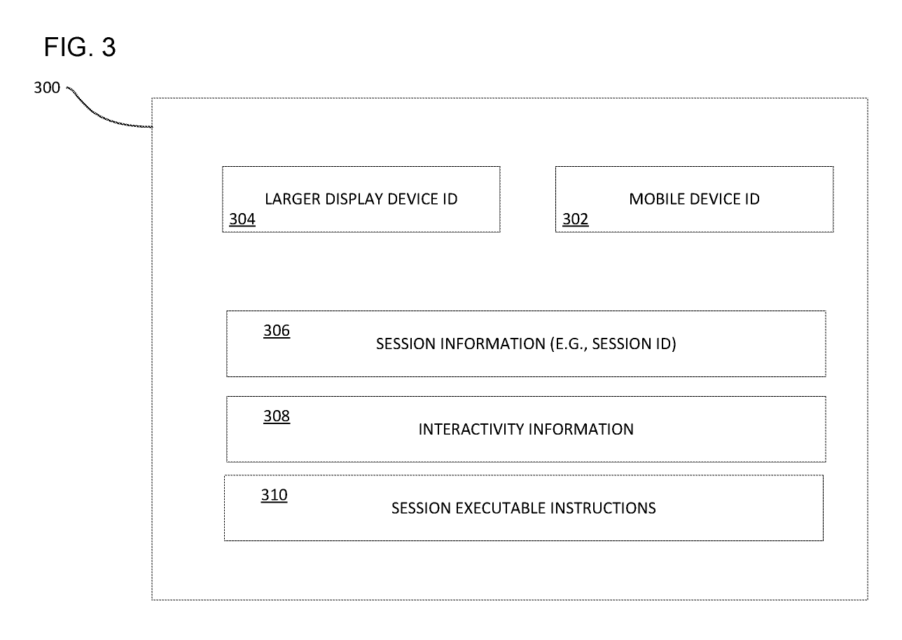

FIG. 3 may illustrate a diagram of exemplary data structure of a data packet transmitted either between a transaction server and a mobile device 112 or between a larger display device 104 and a mobile device 112 according to one embodiment of the invention. In one example, a data structure 300 may include a data field 302 for storing mobile device identification. This data field 302 may be of formats that are known, such as alphanumerical format, text string format, etc., of 8-bit, 16-bit or any other unit. In one embodiment, the data field 302 may be hashed or encrypted. The data structure 300 may further include a data field 304 for an identification of the larger display device 104. In another embodiment, the data structure 300 may include a data field 306 for storing session information of the larger display device 104 or the mobile device 112 (in the alternative embodiment). In one example and not as a limitation, the session information may include time stamps, state of the larger display device 104 or the mobile device 112 with information such as geographical data, battery data, browser state, app state, state information of the wireless devices of the larger display device 104 or the mobile device 112. The data structure 300 may further include a data field 308 for storing interactivity information. In one example and not as a limitation, the interactivity information may include information about/from cookies, information about/from browsing histories, information about/from page cache, information about/from app cache, information about/from wireless devices of the larger display device 104 or the mobile device 112, loyalty program information of the user, payment information of the user, and/or information about/from other parts of the larger display device 104 or the mobile device 112. It is to be understood that the interactivity information may also include information about/from the larger display device 104 or the mobile device 112 relating to the interactive activities that an manufacturer of the larger display device 104 or the mobile device 112 may collect from the user 102 for various purposes, such as diagnostic or enhancement purposes. The data structure 300 further may include a data field 310 for storing session executable instructions or codes. The session executable instructions or codes may include a collection of computer executable instructions for processing information stored in the data structure 300, and computer executable instructions for operating or activating devices or parts of the larger display device 104 or the mobile device 112. In another embodiment, the data field 310 may store the computer executable instructions to monitor or track triggering events. In another embodiment, the session executable instructions may be pushed, updated, or provided by the transaction server 106.

It is to be understood that the data fields 302 to 310 may include other properties. It is also to be understood that each of the data fields in the data structure 300 may be further segmented or divided into different units to meet the storage needs. In addition, the data structure 300 needs not limited to a single file. It may be compressed file or a cab file that may be uncompressed by the processor(s) at the larger display device 104, the mobile device 112 or the transaction server 106. In another embodiment, the data structure 300 may include additional data fields without departing from the scope or spirit of the invention. In another embodiment, the data structure 300 may include metadata and may present the information as metadata matrix using a structured format (e.g., XML), an unstructured format (e.g., TXT file), or a combination of the two.

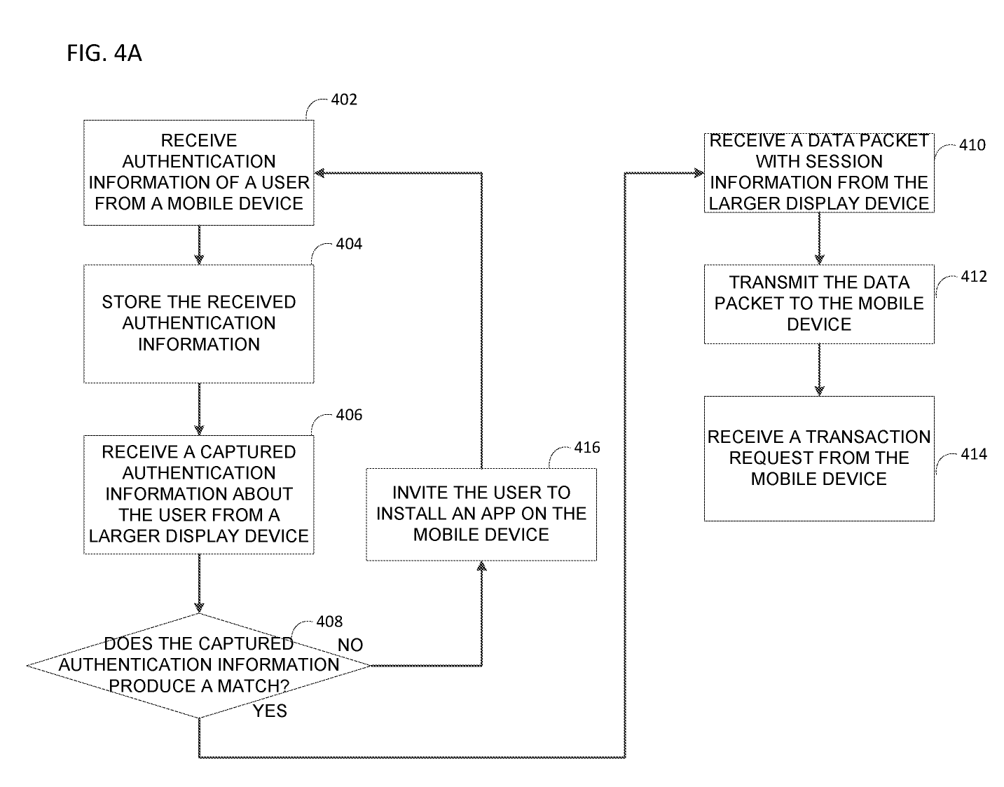

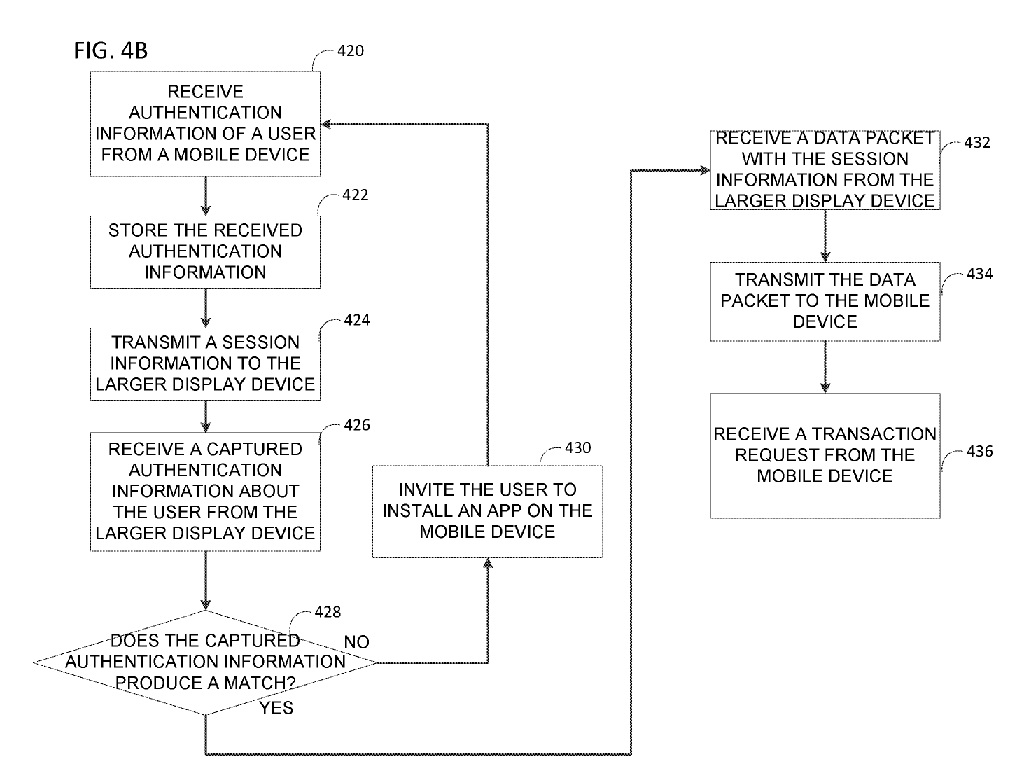

FIG. 4 may illustrate a flow chart of a computerized method of a seamless transition between a small display device to a larger display device according to one embodiment of the invention to complete a transaction. At 402, the method may be implemented on the transaction server 106 or may be part of the overall system that are in a distributed computing environment. At 402, the transaction server 106 may receive an authentication information of a user from a mobile device. At 404, the transaction server 106 may store the received authentication information in a coupled data storage unit. At 406, the transaction server 106 may receive a captured authentication information about the user from a larger display device for verification. At 408, the verification is performed at the transaction server 106. If the determination is negative, the transaction server 106 may include computer executable instructions to cause the larger display device 104 to invite the user to install the app 114 on the mobile device 112 at 416. On the other hand, if the determination is positive, at 410, the transaction server 106 may receive a data packet with session information form the larger display device 104. At 412, the transaction server 106 may transmit the data packet to the mobile device 112 to restore or continue the session. At 414, the transaction server 106 may receive a request to complete a transaction based on the session in the data packet from the mobile device 112.

In alternative embodiment, referring now to FIG. 4B, another method for a seamless transition from a small display device to a larger display device during purchasing interactions. In this embodiment, the transaction server 106 may receive authentication information of a user from a mobile device at 420. At 422, the transaction server 106 may store the received authentication information on a data store. At 424, computer executable instructions from the transaction server 106 may be installed on the mobile device through the app 114. The computer executable instructions may transmit a session information to a larger display device. At 426, the transaction server 106 may receive a captured authentication information about the user from a larger display device for verification. At 428, the verification is performed at the transaction server 106. If the determination is negative, the transaction server 106 may include computer executable instructions to cause the larger display device 104 to invite the user to install the app 114 on the mobile device 112 at 430. On the other hand, if the determination is positive, at 432, the transaction server 106 may receive a data packet with session information form the larger display device 104. At 434, the transaction server 106 may transmit the data packet to the mobile device 112 to restore or continue the session. At 436, the transaction server 106 may receive a request to complete a transaction based on the session in the data packet from the mobile device 112.

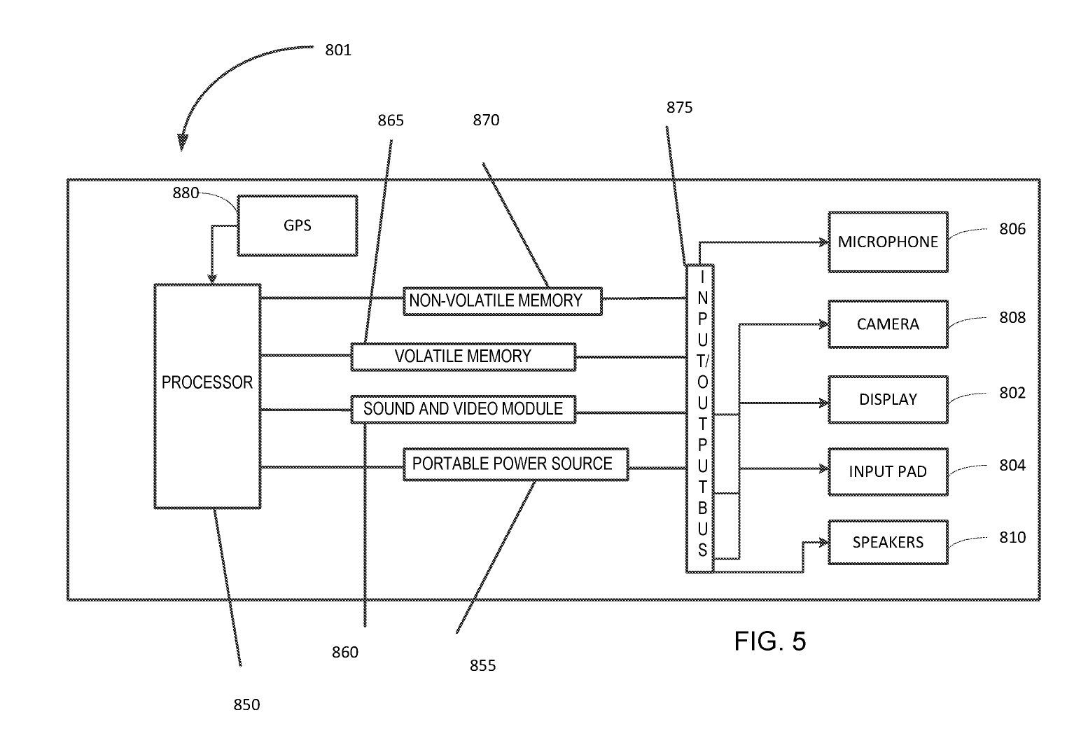

FIG. 5 may be a high level illustration of a portable computing device 801 communicating with a remote computing device 841 but the application may be stored and accessed in a variety of ways. In addition, the application may be obtained in a variety of ways such as from an app store, from a web site, from a store Wi-Fi system, etc. There may be various versions of the application to take advantage of the benefits of different computing devices, different languages and different API platforms.

In one embodiment, a portable computing device 801 may be a mobile device 112 that operates using a portable power source 855 such as a battery. The portable computing device 801 may also have a display 802 which may or may not be a touch sensitive display. More specifically, the display 802 may have a capacitance sensor, for example, that may be used to provide input data to the portable computing device 801. In other embodiments, an input pad 804 such as arrows, scroll wheels, keyboards, etc., may be used to provide inputs to the portable computing device 801. In addition, the portable computing device 801 may have a microphone 806 which may accept and store verbal data, a camera 808 to accept images and a speaker 810 to communicate sounds.

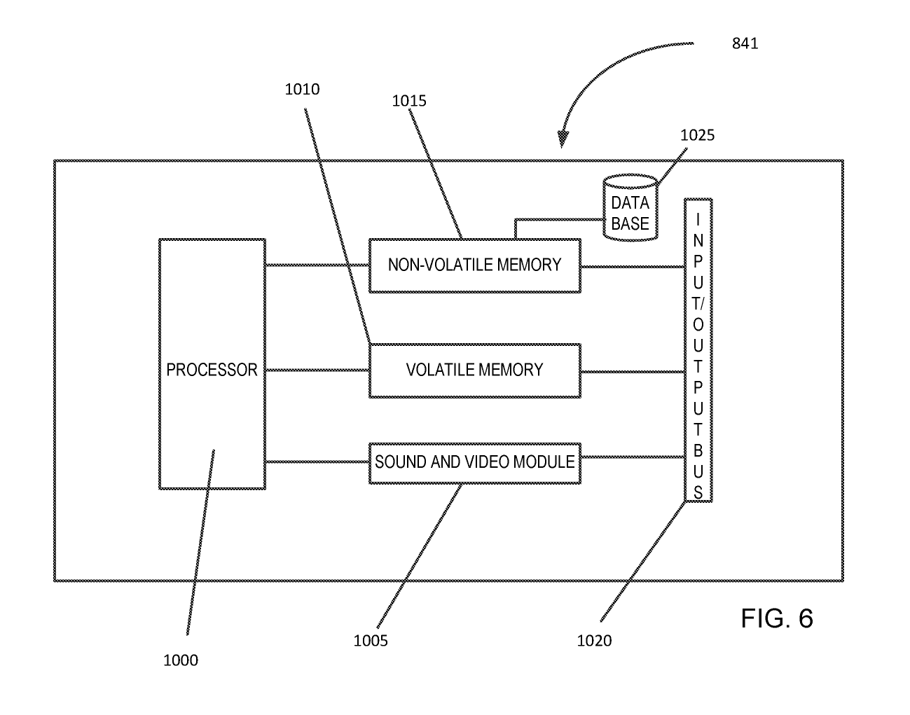

The portable computing device 801 may be able to communicate with a computing device 841 or a plurality of computing devices 841 that make up a cloud of computing devices 811. The portable computing device 801 may be able to communicate in a variety of ways. In some embodiments, the communication may be wired such as through an Ethernet cable, a USB cable or RJ6 cable. In other embodiments, the communication may be wireless such as through Wi-Fi (802.11 standard), Bluetooth, cellular communication or near field communication devices. The communication may be direct to the computing device 841 or may be through a communication network 102 such as cellular service, through the Internet, through a private network, through Bluetooth, etc. FIG. 6 may be a simplified illustration of the physical elements that make up a portable computing device 801 and FIG. 6 may be a simplified illustration of the physical elements that make up a server type computing device 841.

FIG. 5 may be a sample portable computing device 801 that is physically configured according to be part of the system. The portable computing device 801 may have a processor 850 that is physically configured according to computer executable instructions. It may have a portable power supply 855 such as a battery which may be rechargeable. It may also have a sound and video module 860 which assists in displaying video and sound and may turn off when not in use to conserve power and battery life. The portable computing device 801 may also have volatile memory 865 and non-volatile memory 870. It may have GPS capabilities 880 that may be a separate circuit or may be part of the processor 850. There also may be an input/output bus 875 that shuttles data to and from the various user input devices such as the microphone 806, the camera 808 and other inputs, such as the input pad 804, the display 802, and the speakers 810, etc. It also may control of communicating with the networks, either through wireless or wired devices. Of course, this is just one embodiment of the portable computing device 801 and the number and types of portable computing devices 801 is limited only by the imagination.

As a result of the system, better information may be provided to a user at a point of sale. The information may be user specific and may be required to be over a threshold of relevance. As a result, users may make better informed decisions. The system is more than just speeding a process but uses a computing system to achieve a better outcome.

The physical elements that make up the remote computing device 841 may be further illustrated in FIG. 6. At a high level, the computing device 841 may include a digital storage such as a magnetic disk, an optical disk, flash storage, non-volatile storage, etc. Structured data may be stored in the digital storage such as in a database. The server 841 may have a processor 1000 that is physically configured according to computer executable instructions. It may also have a sound and video module 1005 which assists in displaying video and sound and may turn off when not in use to conserve power and battery life. The server 841 may also have volatile memory 1010 and non-volatile memory 1015.

The database 1025 may be stored in the memory 1010 or 1015 or may be separate. The database 1025 may also be part of a cloud of computing device 841 and may be stored in a distributed manner across a plurality of computing devices 841. There also may be an input/output bus 1020 that shuttles data to and from the various user input devices such as the microphone 806, the camera 808, the inputs such as the input pad 804, the display 802, and the speakers 810, etc. The input/output bus 1020 also may control of communicating with the networks, either through wireless or wired devices. In some embodiments, the application may be on the local computing device 801 and in other embodiments, the application may be remote 841. Of course, this is just one embodiment of the server 841 and the number and types of portable computing devices 841 is limited only by the imagination.

The claimed system and method may address several technical problems and challenges, some of which are described. Currently, entering potential sensitive data across networks makes users nervous to the point that a sale may be lost or money or time saving tips or coupons may not be received. By using a proprietary network such as a payment network, to transfer potentially sensitive data, security may be higher and users may be more open to joining additional beneficial programs. Similarly, moving data from one payment system to another loyalty system has felt risky to some users, but by using a proprietary, trusted network, the data may be communicated in a more trustworthy fashion. In addition, formatting data and communicating data in a manner which may be understood by a variety of additional programs is a technical challenge or problem which the system and method has addressed.

The user devices, computers and servers described herein may be general purpose computers that may have, among other elements, a microprocessor (such as from the Intel Corporation, AMD or Motorola); volatile and non-volatile memory; one or more mass storage devices (i.e., a hard drive); various user input devices, such as a mouse, a keyboard, or a microphone; and a video display system. The user devices, computers and servers described herein may be running on any one of many operating systems including, but not limited to WINDOWS, UNIX, LINUX, MAC OS, or Windows (XP, VISTA, etc.). It is contemplated, however, that any suitable operating system may be used for the present invention. The servers may be a cluster of web servers, which may each be LINUX based and supported by a load balancer that decides which of the cluster of web servers should process a request based upon the current request-load of the available server(s).

The user devices, computers and servers described herein may communicate via networks, including the Internet, WAN, LAN, Wi-Fi, other computer networks (now known or invented in the future), and/or any combination of the foregoing. It should be understood by those of ordinary skill in the art having the present specification, drawings, and claims before them that networks may connect the various components over any combination of wired and wireless conduits, including copper, fiber optic, microwaves, and other forms of radio frequency, electrical and/or optical communication techniques. It should also be understood that any network may be connected to any other network in a different manner. The interconnections between computers and servers in system are examples. Any device described herein may communicate with any other device via one or more networks.

The example embodiments may include additional devices and networks beyond those shown. Further, the functionality described as being performed by one device may be distributed and performed by two or more devices. Multiple devices may also be combined into a single device, which may perform the functionality of the combined devices.

The various participants and elements described herein may operate one or more computer apparatuses to facilitate the functions described herein. Any of the elements in the above-described Figures, including any servers, user devices, or databases, may use any suitable number of subsystems to facilitate the functions described herein.

Any of the software components or functions described in this application, may be implemented as software code or computer readable instructions that may be executed by at least one processor using any suitable computer language such as, for example, Java, C++, or Perl using, for example, conventional or object-oriented techniques.

The software code may be stored as a series of instructions or commands on a non-transitory computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus and may be present on or within different computational apparatuses within a system or network.

It may be understood that the present invention as described above may be implemented in the form of control logic using computer software in a modular or integrated manner. Based on the disclosure and teachings provided herein, a person of ordinary skill in the art may know and appreciate other ways and/or methods to implement the present invention using hardware, software, or a combination of hardware and software.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention. A recitation of “a”, “an” or “the” is intended to mean “one or more” unless specifically indicated to the contrary. Recitation of “and/or” is intended to represent the most inclusive sense of the term unless specifically indicated to the contrary.

One or more of the elements of the present system may be claimed as means for accomplishing a particular function. Where such means-plus-function elements are used to describe certain elements of a claimed system it will be understood by those of ordinary skill in the art having the present specification, figures and claims before them, that the corresponding structure is a general purpose computer, processor, or microprocessor (as the case may be) programmed to perform the particularly recited function using functionality found in any general purpose computer without special programming and/or by implementing one or more algorithms to achieve the recited functionality. As would be understood by those of ordinary skill in the art that algorithm may be expressed within this disclosure as a mathematical formula, a flow chart, a narrative, and/or in any other manner that provides sufficient structure for those of ordinary skill in the art to implement the recited process and its equivalents.

While the present disclosure may be embodied in many different forms, the drawings and discussion are presented with the understanding that the present disclosure is an exemplification of the principles of one or more inventions and is not intended to limit any one of the inventions to the embodiments illustrated.

The present disclosure provides a solution to the long-felt need described above. In particular, the systems and methods described herein may be configured for improving user transaction systems. Further advantages and modifications of the above described system and method will readily occur to those skilled in the art. The disclosure, in its broader aspects, is therefore not limited to the specific details, representative system and methods, and illustrative examples shown and described above. Various modifications and variations can be made to the above specification without departing from the scope or spirit of the present disclosure, and it is intended that the present disclosure covers all such modifications and variations provided they come within the scope of the following claims and their equivalents.

What is claimed is:

1. A system for a seamless transition between a first device with a first display size to a second device with a second display size during a purchasing interaction comprising:
a transaction server, coupled to a data storage unit, being configured to receive authentication information of a user from a first device, wherein the transaction server is accessible to the data storage unit and the first device via a communications network;
wherein the transaction server stores the authentication information in the data storage unit;
at a second device remote with respect to the first device: the second device is configured to capture a potential authentication information from the user and interactions with the user, wherein the second device generates session information in response to the interactions with the user, wherein the session information identifies a state of the interactions of the user on the second device;
wherein the second device transmits the potential authentication information to the transaction server for comparing the potential authentication information with the authentication information stored in the data storage unit; and
in response to receiving a successful verification of the potential authentication information, the second device is configured to transmit a data packet including the session information for completion of the purchasing interaction at the transaction server.

2. The system of claim 1, wherein the second device is configured to determine the interactions as the purchasing interaction, and wherein the second device generates the session information in response to determining that the interactions comprises the purchasing interaction.

3. The system of claim 1, wherein the first device is further configured to install a software program product thereon to initiate mobile interactions with the user, wherein the mobile interactions comprise obtaining at least one of the following information from the user: the authentication information and personal information.

4. The system of claim 3, wherein the first device transmits the obtained authentication information or the personal information to the transaction server.

5. The system of claim 3, further comprising, at the first device remote with respect to the second device and the transaction server, the first device is configured to receive the data packet from the transaction server in response to receiving the data packet from the second device.

6. The system of claim 3, further comprising, at the first device remote with respect to the second device and the transaction server, the first device is configured to receive the data packet from the second device.

7. The system of claim 5, wherein the first device is configured to receive interactions with the user based on the session information to complete the purchasing transaction with the transaction server.

8. The system of claim 5, wherein the first device is configured to execute the software program product on the first device to process the data packet from the transaction server, wherein the first device is configured to apply the session information included in the data packet to restore the state of the interactions on the first device.

9. The system of claim 6, wherein the first device is configured to receive interactions with the user based on the session information to complete the purchasing transaction with the transaction server.

10. The system of claim 6, wherein the first device is configured to execute the software program product on the first device to process the data packet from the second device, wherein the first device is configured to apply the session information included in the data packet to restore the state of the interactions on the first device.

11. The system of claim 1, wherein the transaction server is configured to receive authentication information comprises the transaction server being configured to receive authentication information in response to receiving configuration information of the user at the first device.

12. A computerized method for providing a seamless transition between a first device with a first display size and a second device with a second display size during a purchasing transaction comprising:
receiving, by a transaction server, authentication information of a user from a first device, wherein the transaction server is accessible to a data storage unit and the first device via a communications network;
storing, by the transaction server, the authentication information;
receiving, by the transaction server, a potential authentication information from the user captured by a second device, for comparison of the potential authentication information to the authentication information stored in the data storage unit;
determining, by the transaction server, the potential authentication information matches the authentication information stored in the data storage unit;
transmitting, by the transaction server, a response to the second device in response to the determining; and
in response to the transmitted response being a successful verification of the potential authentication information, receiving, by the transaction server, a transaction request from the first device to complete the purchasing transaction at the transaction server.

13. The computerized method of claim 12, wherein the data packet includes the one or more data fields for storing at least the following information, in addition to the session information: a second device ID, a first device ID, a session ID, interactivity information, and session executable instructions.

14. The computerized method of claim 12, further comprising receiving a data packet from the second device, said data packet including session information, said session information identifying a state of the interactions of the user on the second device.

15. The computerized method of claim 12, further comprising receiving a data packet from the first device, said data packet including session information, said session information identifying a state of the interactions of the user on the first device and the second device.

16. The computerized method of claim 15, wherein the data packet includes the transaction request in response to the first device restoring the state of the interactions according to the session information on the first device.

17. A computerized method for providing a seamless transition between a first device with a first display size and a second device with a second display size during a purchasing transaction comprising:
instantiating a set of computer executable instructions on the first device in response to receiving the set of computer executable instructions;
interacting, executing the set of computer executable instructions by a processor on the first device, with the user on the first device to receive authentication information;
transmitting, by the processor of the first device, the received authentication information to a transaction server, said transaction server being remote with respect to the first device;
storing a first session information on the first device;
receiving a data packet on the first device, said data packet including a second session information, said second session information including information of a state of a purchasing interaction;
based on the second session information, restoring the state of purchasing interaction on the first device in the instantiated set of computer executable instructions; and
transmitting a transaction request from the first device to the transaction server to complete the purchasing interaction.

18. The computerized method of claim 17, wherein receiving the data packet on the first device comprises receiving the data packet from a second device, wherein the second device is different from the first device, wherein the second device generates the second information session based on a set of user interactions on the second device.

19. The computerized method of claim 17, further comprising transmitting the first session information from the first device to the second device.

20. The computerized method of claim 19, wherein the data packet includes the first session information as part of the second session information.
